(19) United States
(12) Patent Application Publication
(10) Pub. No.: US 2007/0294442 A1
(43) Pub. Date: Dec. 20, 2007

(54) Storage media having electronic circuit and computer system including storage media

(75) Inventors: Takashi Shigetomi, Miyagi-ken (JP); Tetsuo Saito, Miyagi-ken (JP); Tsunematsu Komaki, Tokyo (JP)

Correspondence Address: Attention of Brian H. Batzli;MERCHANT & GOULD P.C, P.O. Box 2903, Minneapolis, MN, 55402-0903, US

(73) Assignee: IntelligentDisc, Inc., Yokohama-shi (JP)

(21) Appl. No.: 11/880,540

(22) Filed: Jul. 23, 2007

Related U.S. Application Data
(63) Continuation of application No. 09/912,711, filed on Jul. 25, 2001.
Application No. 09/912,711 is a continuation of application No. 09/052,408, filed on Mar. 31, 1998, now abandoned.

(30) Foreign Application Priority Data
Jun. 19, 1997 (JP) 9-162962

(51) Int. Cl. G06F 13/12

(52) U.S. Cl. 710/74

(57) ABSTRACT

A storage media for automating a control and a computer system including the storage media, which abolishes the restriction between the hardware models and the software processes, and in which a desired software process can be simply utilized in any hardware models, and a computer system including the storage media are provided. In the intelligent disk 1 having the disk 3 for storing information and the electronic circuit portion 2 for processing the information, the disk stores a plurality of information to be used in an external system, and wherein the electronic circuit portion distinguishes the information stored in the disk, which matches with the external system. Also, the disk unit or the electronic circuit further includes an emulator for matching the system program with the external system.

### CROSS REFERENCE TO RELATED APPLICATIONS

This application is a continuation of application Ser. No. 09/912,711, filed Jul. 25, 2001, which is a continuation of application Ser. No. 09/052,408, filed Mar. 31, 1998, which applications are incorporated herein by reference.

### BACKGROUND OF THE INVENTION

1. Field of the Invention

The present invention relates to a storage media having an electronic circuit, and a computer system including this storage media.

2. Description of the Related Art

Conventionally, in a computer system, since a particular model is developed for a particular computer Operating System (hereinafter, it is referred to as OS) as a software, it is very rare for a plurality of OS's desired by a user to run on one model, or for the same OS to run on the computers of a plurality of manufacturers.

Recently, it has been made possible to emulate different OS's running on different systems.

However, in order to modify the OS, it is necessary to pre-load the emulator within the system or to read-in the emulator and/or the OS from the designated disks, or there are also various other restrictions, so it was not a state in which a desired OS would be run by simply modifying the OS to the desired one.

In the above, an example of the OS is described, but there are various restrictions and burdens to the users, from a wide view point of correspondence between conditions and environments of a hardware and a software.

### SUMMARY OF THE INVENTION

The present invention provides a storage media and a computer system including the storage media, which eliminates the above described conventional disadvantages, abolishes the restriction between the hardware models and the software processes, and in which a desired software process can be simply utilized in any hardware models, and which automates the control.

According to the present invention, the foregoing object is attained by providing a storage media having an information storage portion for storing information and an electronic circuit portion for processing the information,

the information storage portion storing information to be used in an external system, and

the electronic circuit portion including discrimination means for discriminating whether or not the external system is matched with the information stored in the information storage portion.

According to another aspect of the present invention, the foregoing object is attained by providing a storage media having an information storage portion for storing information and an electronic circuit portion for processing the information,

the information storage portion storing a plurality of information to be used in an external system, and

the electronic circuit portion including selecting means for selecting information stored in the information storage portion, and matched with the external system.

In still another aspect of the present invention, the foregoing object is attained by providing a storage media having an information storage portion for storing information and an electronic circuit portion for processing the information,

the information storage portion storing a plurality of information to be used in the external system, and

the electronic circuit portion including a selecting means for selecting information stored in the information storage portion, and matched with a present state of the external system.

In still another aspect of the present invention, the foregoing object is attained by providing a storage media having an information storage portion for storing information and an electronic circuit portion for processing the information,

the information storage portion storing information to be used in the external system, and

the electronic circuit portion including notifying means for notifying an identifier of an information stored in the information storage portion to the external system.

In still another aspect of the present invention, the foregoing object is attained by providing a computer system including a storage media having an information storage portion for storing information and an electronic circuit portion for processing information, and a computer capable of connecting the storage media,

the computer reading a system program and/or an emulator from the storage media, and pseudo-running a system program of a different computer.

In still another aspect of the present invention, the foregoing object is attained by providing a computer system including a storage media having an information storage portion for storing information and an electronic circuit portion for processing an information, and a computer capable of connecting the storage media,

the electronic circuit allowing to be read a system program suitable for the computer from the information storage portion and

starting up the system program of the computer.

In still another aspect of the present invention, the foregoing object is attained by providing a computer system including a storage media having an information storage portion for storing information and an electronic circuit portion for processing information, and a computer capable of connecting the storage media,

the computer system further including a printer,

the computer reading a parameter for adjusting a printing environment from the storage media, and

allowing to implement a printing suitable for the printing environment.

In still another aspect of the present invention, the foregoing object is attained by providing a computer system including a storage media having an information storage portion for storing information and an electronic circuit portion for processing an information, and a computer capable of connecting the storage media,

the computer system further including a printer,

the computer reading an identifier from the electronic circuit and controlling a writing of the information stored in the information storage portion to the computer.

According to an embodiment, the external system is a personal computer system, and

the information stored in the information storage portion is a system program.

According to an embodiment, the information storage portion or the electronic circuit portion further has information which allows the information stored in the information storage portion to be matched with the external system.

According to an embodiment, the information to be matched is an emulator of a system program.

According to an embodiment, the external system is a computer system having a printer, and

the information stored in the information storage portion is a parameter for adjusting a print condition.

According to an embodiment, the storage media is an optical disk.

According to an embodiment, the external system is a computer system for processing a digital image data, and the information stored in the information storage portion is a digital image data taken by a digital camera.

According to an embodiment, the storage media is an optical disk.

Other features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is an exterior view of an intelligent optical disk which is one type of the ID of an embodiment of the present invention;

FIG. 2 is a diagram showing a concept of a configuration of a computer system which includes the ID;

FIG. 3 is a diagram showing an example of storage content of the ID in the embodiment 1 to a personal computer;

FIG. 4 is a flowchart showing an example of operation of the system and the circuit unit/the disk unit of the ID in FIG. 3;

FIG. 5 is a diagram showing an example of storage content of the ID in the embodiment 2 to the personal computer;

FIG. 6 is a flowchart showing an example of operation of the system and the circuit unit/the disk unit of the ID in FIG. 5;

FIG. 7 is a diagram showing an example of storage content of the ID in an embodiment to a computer having a printer;

FIG. 8 is a flowchart showing an example of operation of the system and the circuit unit/the disk unit of the ID in FIG. 7;

FIG. 9 is a diagram showing an example of storage content of the ID in an embodiment to a computer which processes a digital image; and

FIG. 10 is a flowchart showing an example of operation of the system and the circuit unit/the disk unit of the ID in FIG. 9.

### DESCRIPTION OF THE PREFERRED EMBODIMENTS

In the following, a few examples of the embodiments of the present invention will be described in accordance with the accompanying drawings.

### A Configuration Example of the ID (Intelligent Disc) and the ID System in an Aspect of the Present Embodiment

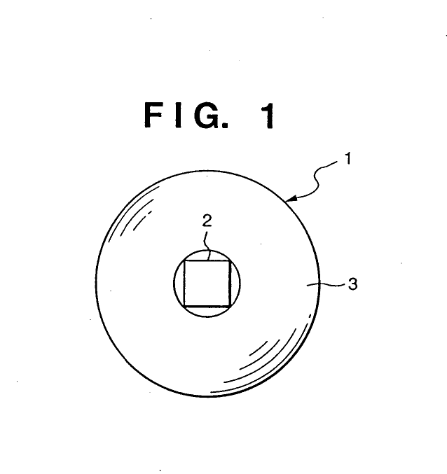

FIG. 1 is an exterior view of the intelligent optical disk which is one model of the ID of an aspect of the present embodiment.

The ID 1 is composed of a disk 3 which is a disk surface to store information, and an intelligent circuit portion 2 equipped at the central part thereof. Here, although the circuit portion 2 is placed at the central part of the disk in FIG. 1, it does not have any particular restriction for its placement, such as making one side of the disk to be dedicated therefor, or producing the multiple layers of disks and then placing it in a layer among multiple layers of disks.

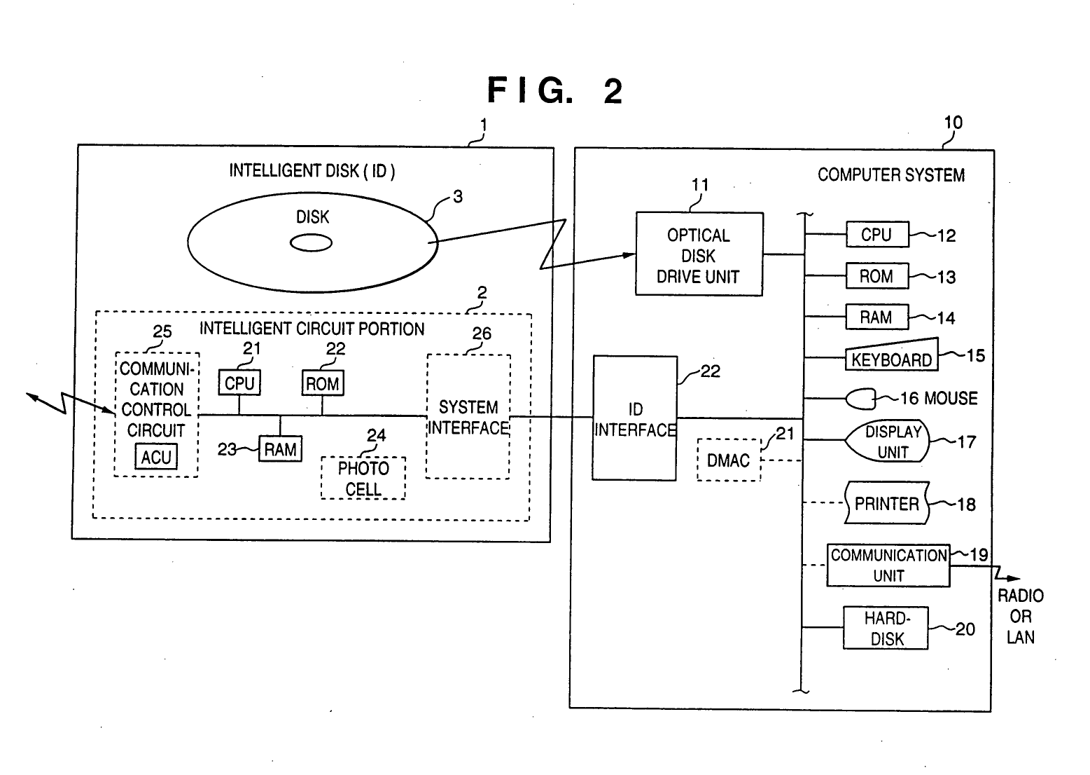

FIG. 2 is a diagram showing a concept of a configuration of the computer system which includes the ID 1.

In the figure, the above described intelligent circuit portion 2 includes a ROM 22 for storing a fixed information, a RAM 23 as a temporary storage if necessary, and a CPU 21 for running program(s) stored in the ROM 22 and/or the RAM 23. Numeral 24 indicates a photo battery which is required when the ID side has a power supply independently.

The intelligent circuit portion 2 exchanges information with an external device, through a system interface 26. A contact point of the interface may either be a physical contact type or a non-physical contact type, or may either be a buss coupling or a wireless communication coupling. As a wireless communication, an electric wave communication, an optical communication and the like could be considered.

In addition, the ID 1 of an aspect of the present embodiment has a radio wave communication unit 25, and also has an ability of implementing an auto-call when a transmission of information to the outside is required, or when loading of data or program from the outside is needed.

On the other hand, the numeral 10 indicates a personal computer which is commercially available. The system has, as a processor unit, a ROM 13 for storing fixed information, a RAM 14 as a further temporary storage if necessary, and a CPU 12 for running program(s) stored in the ROM 13 and/or the RAM 14, and it has, as a permanent element, an optical disk drive unit 11 including a pickup for reading (writing) of data from (to) the disk 3 of the ID of the present example, and a driving circuit of the pickup and the like, a display unit 17 (preferably, LCD) for displaying information or the status of the system, a keyboard 15 (this could be replaced with a touchpanel on the display unit 17) for entering instructions of the user, and a mouse 16 (to be omitted in a portable personal computer) for similarly entering instructions of the user, and the like.

Furthermore, there are a hard disk 20 as a buffer memory for storing data or a program, a direct memory access controller (DMAC) 21 for carrying out a transfer independently and in high speed, a printer 18 for use in a hardcopy output, a communication unit 19 for connecting to the radio communication or a LAN (Local Area Network), and an ID interface 22 for use in a connection as described in the illustration of the ID.

Further, in the above description, it is described as a system which can be used as a personal computer however it can also be a dedicated device for, for example, a display to the display unit 1, a print output to the printer 7, or preservation of information into the hard disk 16. However, even in these cases, the optical disk drive unit 11 is always a required element in the system.

When improving a conventional device, although it is necessary to match the system side and the ID side through the ID interface 22 and the system interface 26, it is preferable that the interface (also in a case of a bus coupling) be standardized so that any system and any ID can be easily coupled.

### An Application Example 1 to the Personal Computer of an Aspect of the Present Embodiment

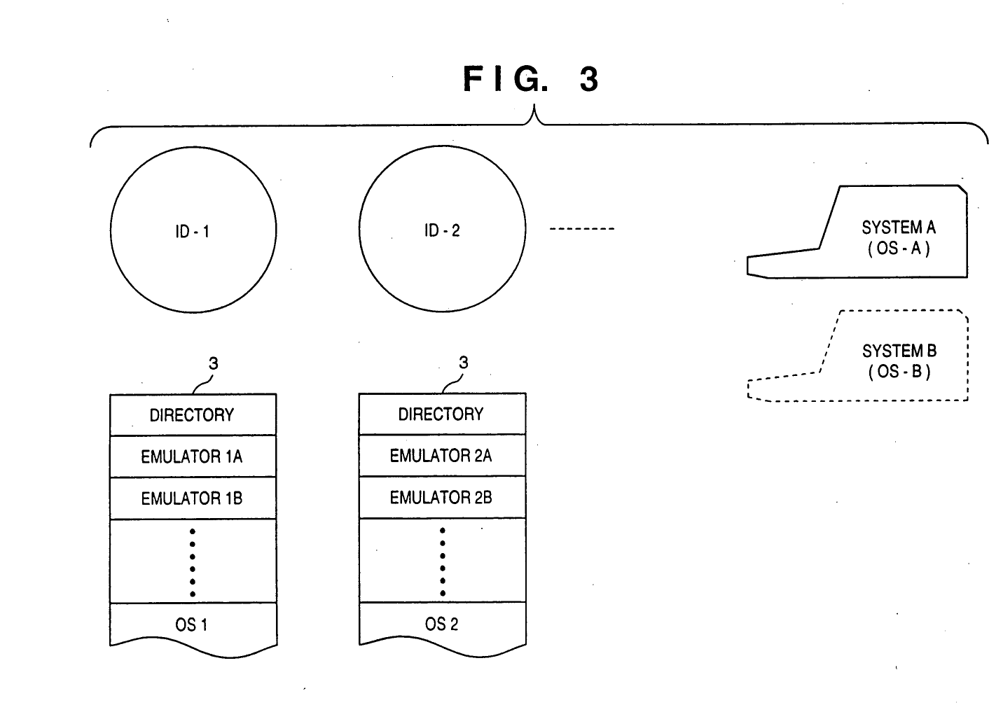

FIG. 3 is an example showing the storage contents of the ID 1, when carrying out a different system program (OS), in one of the personal computers.

In the present example there are several IDs (ID-1, ID-2, . . . ), and in each ID a unique OS (OS-1, OS-2, . . . ) is stored, and a plurality of emulators for running this unique OS in the various systems are stored. For example, in the ID-1 the emulator 1A for running the OS-1 in system A, the emulator 1B for running it in system B, and the like are stored, and in the ID-2 the emulator 2A for running the OS-2 in system A, the emulator 2B for running it in system B, and the like are stored.

Further, in the present example, the system A or the system B is operated with the OS for its own model (OS-A, OS-B, . . . ), respectively, and pseudo-implements other OS based on this OS for its own model.

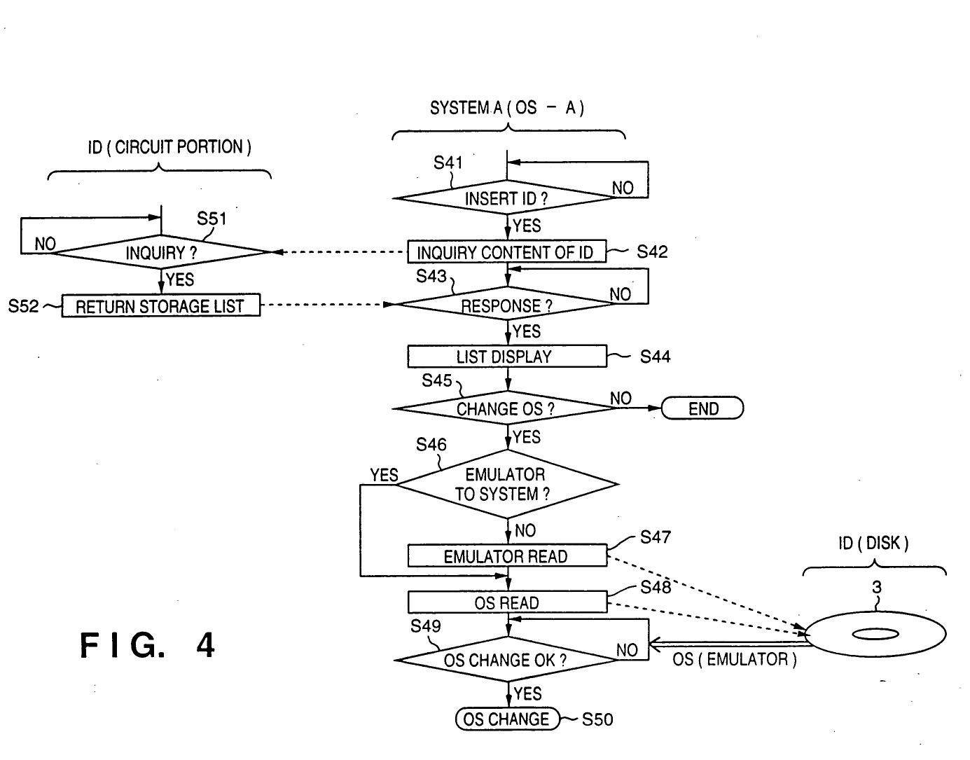

FIG. 4 is a flowchart showing an example of operations of system A and the circuit unit/the disk of the ID in the present example (an example of system A).

First, the system A running with OS-A is checking the insertion of the ID 1 at the step S41. This check could be carried out periodically, but an interrupt process is preferable. Proceeding to the step S42 when the ID 1 is inserted, and the system A inquires for what kind of the ID the ID 1 is.

The circuit portion 2 of the ID waits for an inquiry from the system in the step S51, and proceeds to the step S52 when there is an inquiry and returns a list of the storage contents (which list has been stored in the ROM 22 (RAM 23)) of the above described disk 3. In this moment, for example, if the format and the like of data on the disk 3 are different from the standard of the system A, they are also informed from the circuit portion 2 to the system A. As such, the present example is an effective method when a standardization of the system device has not been established.

The system A waits for a response from the circuit portion 2 of the ID in the step S43, and proceeds to the step S44 when there is a response, and then displays on the display unit 17 the list which was sent from the circuit portion 2. When a user does not wish to change the OS, the answer to S45 is NO and the program leaves step S45 and ends.

When there is a designation that the user wishes to change the OS, it proceeds to the step S46, and checks if the system A has an emulator for the OS (OS-1 or OS-2) selected on the ID. If there is, then it proceeds to the step S48 and reads a desired OS on the ID, and if the transfer is good then it proceeds from S49 to S50 and carries out the change of the OS. When there is no matching emulator on system A, it reads a suitable emulator together with an OS from the ID in the step S47, and carries out a change of the OS.

Further, although it is not shown in the present example, when there is no desired emulator, a means for downloading by making an auto-call from the communication control circuit 25 of the ID to a software provider, is possible. Also, in the above mentioned example, the emulator has been stored in the disk 3, but it may be stored in the ROM 22 or RAM 23 of the circuit portion 2.

### An Application Example 2 to the Personal Computer of an Aspect of the Present Embodiment

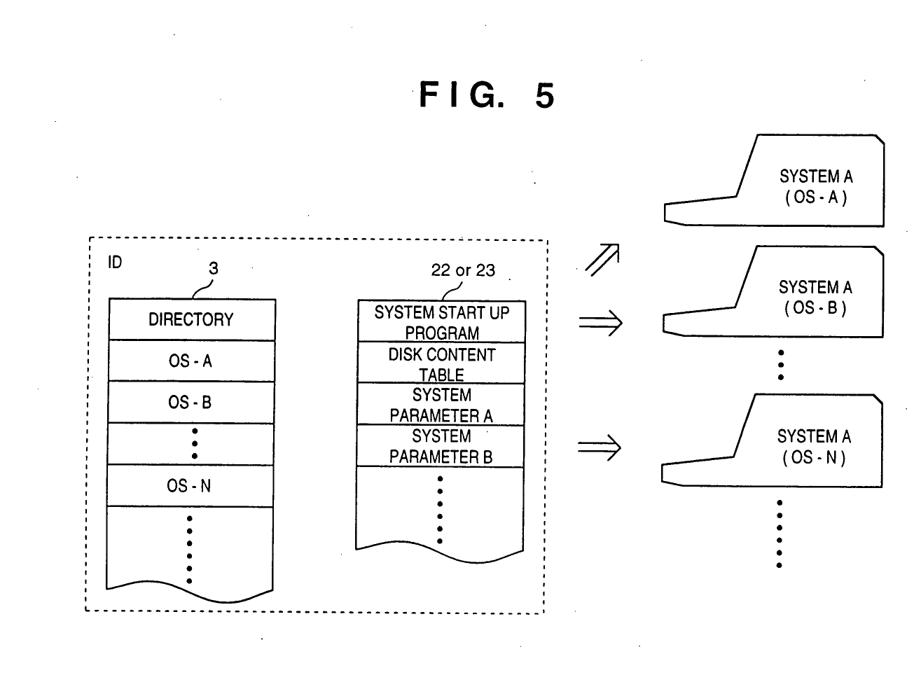

FIG. 5 is an example showing the storage contents of the ID, when it is possible to make the startup of a plurality of different personal computers by one ID. Herein, the system A, the system B, . . . , the system N are the systems which operate with the different OS's (OS-A, OS-B, . . . , OS-N).

In the disk unit of the ID, the OS-A, OS-B, . . . , OA-N used in each system are stored in the position pointed by the directory. Also, in the ROM 22 (RAM 23) which exists in the circuit portion 2 of the ID, a system start-up program for starting up a system, a table for indicating the content of the disk unit, and parameters (a parameter A, a parameter B, . . . ) required in each of the systems for starting up each system are stored.

Further, the present example is a method which can be applied when the standardization of each system proceeds.

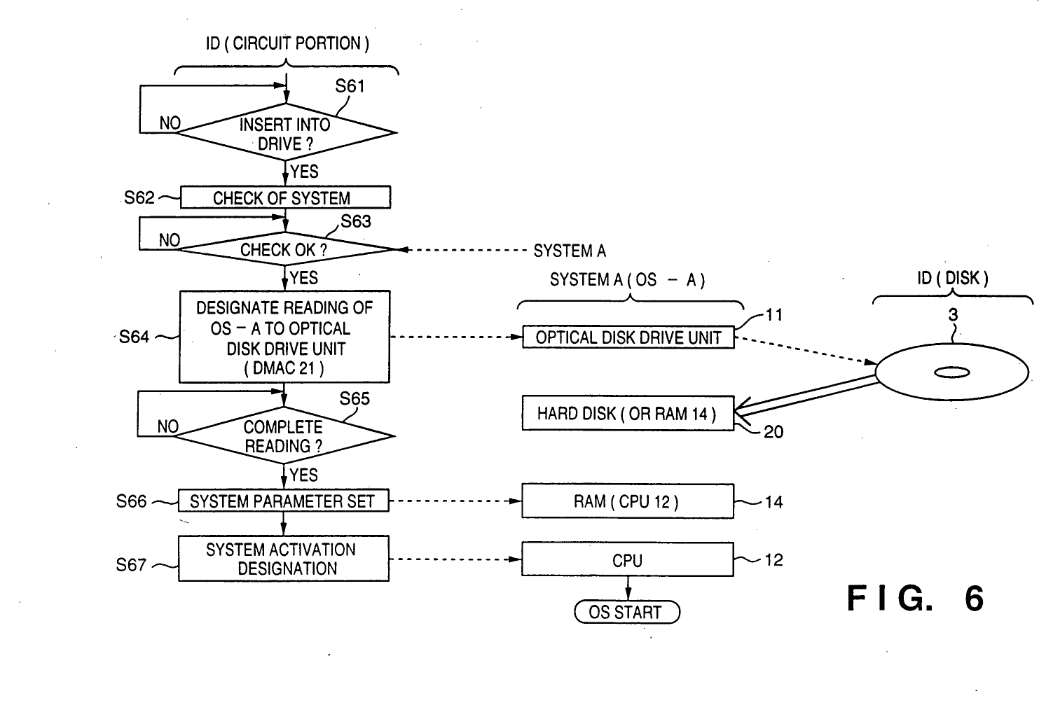

FIG. 6 is a flowchart showing an example of a procedure for starting up the system A in the present example. The system is in an initial stop state.

At first, the circuit portion 2 of the ID checks whether or not the ID 1 is inserted into the drive in the step S61. If it is, it proceeds to the step S62, and checks the manufacturer, the model, the version, etc. of the system to which the inserted drive is connected. If the necessary information for the system start up is obtained in checking the system, then it proceeds from the step S63 to S64, and designates to an optical disk drive unit 11, to read the corresponding OS (in the present example, the OS-A) by reference to the disk content table. In this case, if it is a system having a DMAC 21, then it will be used.

When the OS is read from the disk 3 to the hard disk 20 or the RAM 14 by the optical disk drive unit 11, the circuit portion 2 proceeds from the step S65 to S66 after the completion of the read-out, and sets the parameter corresponding to the system to the RAM 14 or to appropriate registers of the CPU 12, etc., and at the step S68 designates to the CPU 12 the start up of the system.

According to such procedure as mentioned above, the various systems can be started up with the OS corresponding to that system by one piece of the ID 1.

In the above two examples, two extremes are shown such as an example in which the ID functions only as one of the peripheral devices of the system, and an example in which the ID is used main-operationally starting up the system, but according to the degree of the standardization of the system device, allocations of the various roles of the ID's and the systems among these can be considered.

### An Application Example to a Computer System to which a Printer of an Aspect of the Present Embodiment is Connected

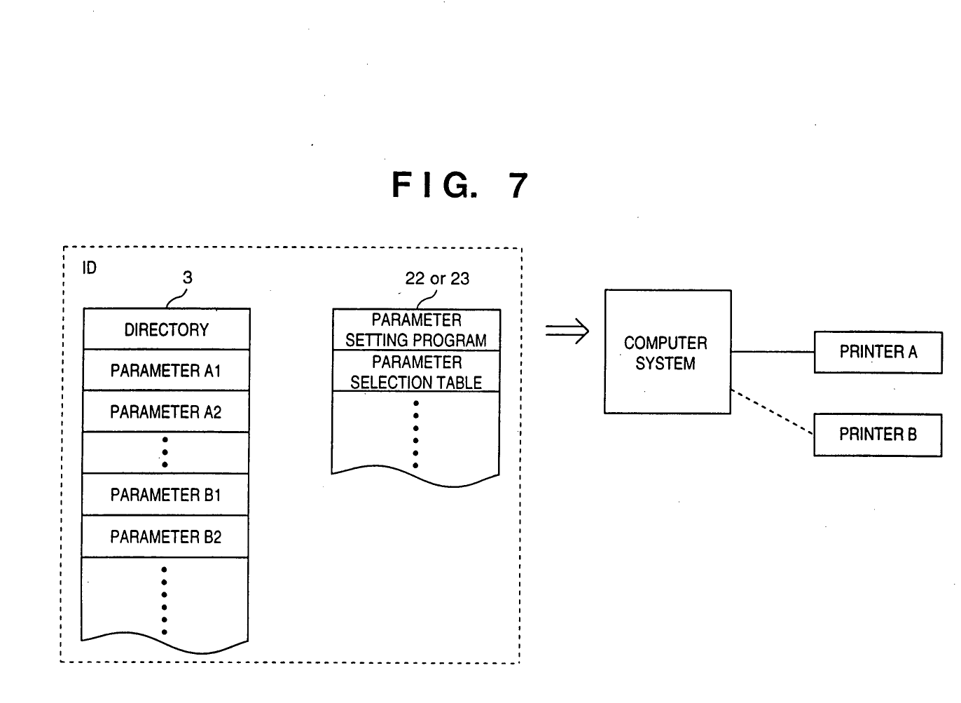

FIG. 7 is a diagram showing the storage contents of the ID for use in the parameter adjustment in a system to which printers having different characteristics (a printer A, a printer B, . . . ) are connectable, or in a system to which a high quality printer, that requires a fine adjustment according to a print condition (a size and a tone, a print content, etc.) and an environment condition (a temperature, a humidity), is connected.

In the disk 3 of the ID, in a position to which a directory points, the parameters (parameters A1, A2, . . . ) for use in the printer A, which differ according to the conditions, and the parameters (parameters B1, B2, . . . ) for use in the printer B are stored.

On the other hand, in the ROM 22 (RAM 23) of the circuit portion 2 in the ID, a parameter selection table in which information of what parameter should be selected based on a condition is stored, and a program for setting the selected parameter and the like to a printer, are stored.

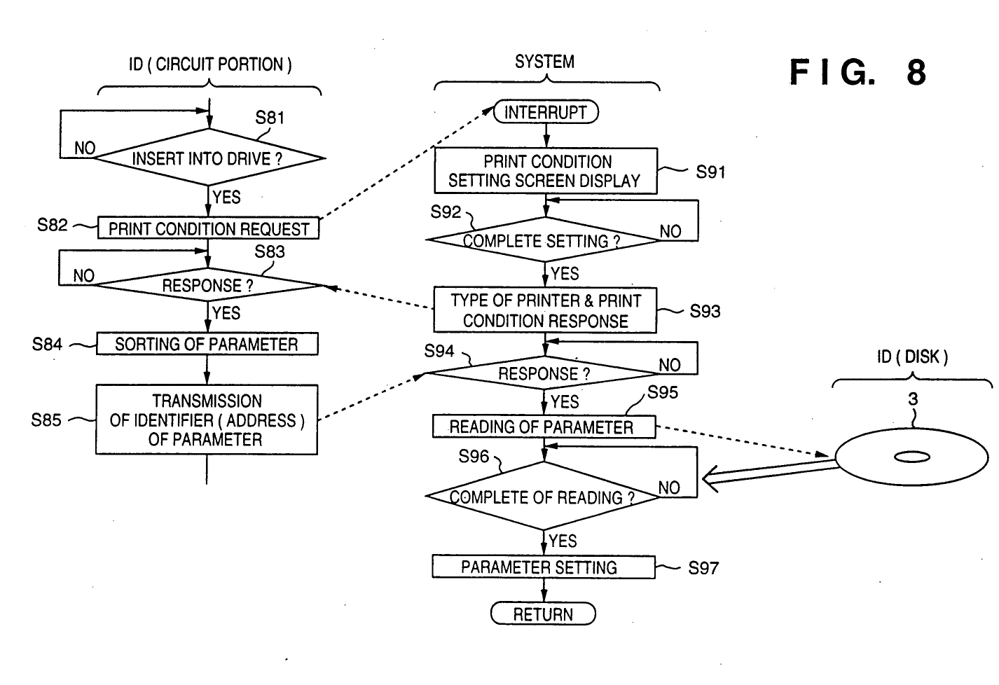

FIG. 8 is a flowchart showing an example of a procedure for a parameter change in the present example. As an assumption, for a change from the printer A to the printer B of a different model, it is obvious to require a procedure under which a printer driver within the computer system will be changed. The present example especially relates to a fine adjustment of the print state thereafter.

At first, the circuit portion 2 on the ID checks on insertion of the ID into a drive in the step S81, proceeds to the step S82 if inserted, and then requests to the system 10 the data of the print condition.

The system 10 receives a request from the ID 1 as an interrupt, enters into an interrupt routine, and displays a setting screen on which print conditions can be set by a user on the display unit 17 in the step S91. Having completed the setting it proceeds from the step S92 to S93, and sends to the ID 1 print conditions and the environment condition which are set by a user, together with the information of the printer model and the like.

In the ID 1, upon receiving a response from the system 10, it proceeds from the step S83 to S84, then referring to the parameter selection table from the response information, sorts the most suitable parameter in the overall present conditions, and sends to the system 10 an address on the disk in which that parameter is stored, or an identifier thereof in the step S85.

In the system 10, upon receiving a response from the ID 1, it proceeds from the step S94 to S95, reads the parameter, which has been designated, from the disk 3, and having completed the read, it proceeds from the step S96 to S97, passes the parameter just read, for example in a printer driver or to a program which controls the printer driver, or incorporates the parameter into a software in which a printer condition can be changed by carrying out a download and the like to the printer, then returns from the interrupt routine.

### An Application Example to a Digital Camera System of an Aspect of the Present Embodiment

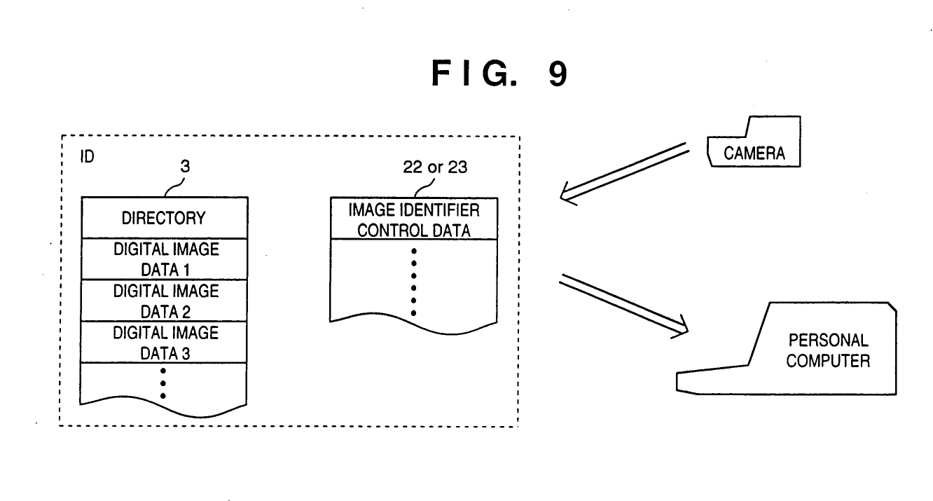

FIG. 9 is a diagram showing the storage contents, within the ID used for transferring the image information taken by a digital camera to a computer system such as a personal computer.

In the disk 3 of the ID, at the position to which the directory points, a plurality of the image data captured by the digital camera are stored in the order of a time sequence. On the other hand, in the circuit portion 2 of the ID, in order that the data is not to be lost within the computer by an overwrite of the image data, the image identifier control data for controlling the image identifier is stored.

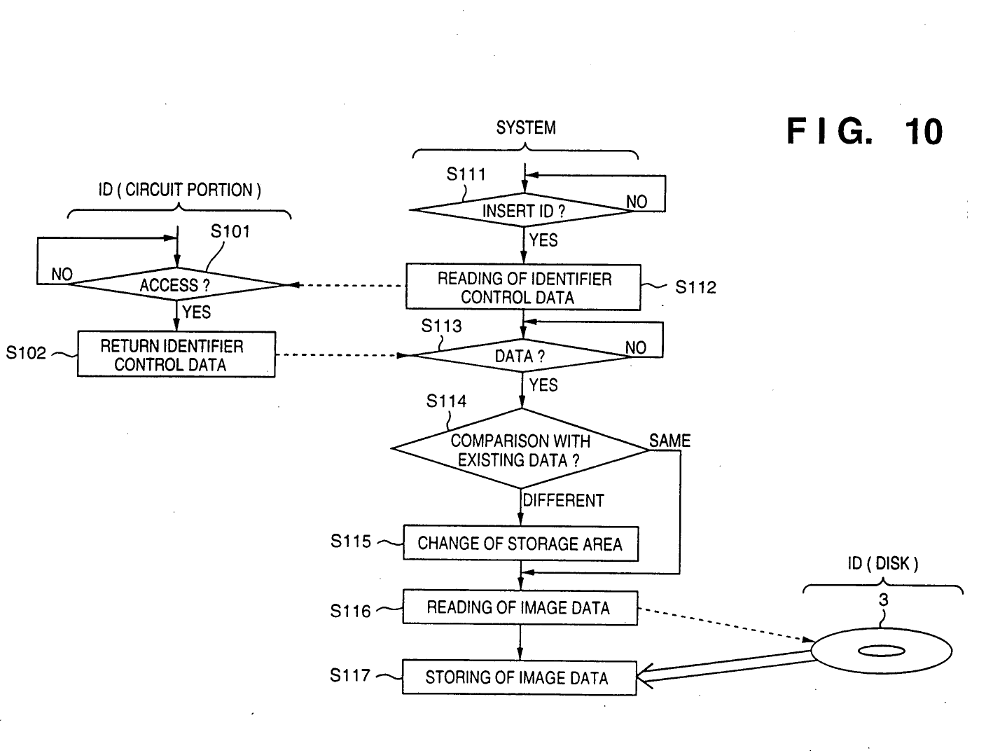

FIG. 10 is a flowchart showing a processing procedure between the personal computer system and the ID in the present example.

The system 10 waits for an insertion of the ID 1 in the step S111. When there is the insertion of the ID 1 it proceeds to the step S112, and reads the above mentioned identifier control data. In the ID 1, it waits for an access for this read at step S101, and returns the identifier control data in the step S102 when there is an access.

The system 10 proceeds to the step S114 upon receiving the data from the ID 1 in the step S113, and compares the received data with the identifier control data of the image data which has already been stored in the system 10. Further, as the identifier control data, the date and time information, and the information which is entered by operating the camera, and the like can be considered, but it could be anything which causes each image data to have a unique identifier.

When the identifier control data differs, the system 10 reserves the storage area which differs from the area which has already been stored, even if the identifier of the image data stored in the disk 3 is the same as the identifier of the image data which has already been stored within the system 10, so as not to lose the image data by overwriting. If the identifier control data are the sane, the storage area is not altered.

In the step S116, the system 10 reads the image data from the disk 3 of the ID, and stores the read image data within the system 10 in the step S117, but the system 10 will be controlled in such a manner that the read image data is overwritten when the identifier control data are the same, and the previous data is preserved and the read image data is written into another area when the identifier control data are different.

According to the above mentioned ID, the computer industry could be free from the oligopolistic controls of the CPU and OS manufacturers, and an ID which has been installed with the most suitable CPU for each software could be sold by the software manufacturers. Also, the hardware manufacturers can escape from the present situation in which hardware manufacturers become a business of producing no profit by forcing them to make model changes three to four times per year with the frequent improvements of the CPU.

For the user, the ID could enhance convenience. For example, since the existing software is not easy to use unless it is copied once from the CD-ROM and the like to the hard disk, the capacity of the hardware is immediately filled up, thereby an add-in of the hardware or an upgrade of the computer itself must be done, but with the ID no such things are necessary, and any trouble associated with attachment and detachment of hardware such as the hard disk is avoidable.

That is, according to the ID, it is possible to provide a flexible provision for changes and the like of the specifications such as the improvement of the CPU, as well as to avoid the events which cause a loss of convenience of the user such as incompatibility of the hardware according to a difference of the OS or the format. Using the ID, the hardware, which has been viewed as a computer itself conventionally, becomes merely a man-machine interface (i.e., one which is a combination of display and keyboard and the like), and can be placed among home electrical products such as the TV and VCR, i.e., consumer durables, and thereby the convenience for the user can be enhanced substantially and the added value can be enhanced for the manufacturers in a direction of putting some thought into the design and function thereof.

Further, at the present time, the waste handling of the computers becomes a social problem, but this problem is caused by abnormal model changes which become obsolete within three months on an average, in the computer industry. The ID will eliminate the cause thereof, make the computer industry to be free from the oligopolistic control, and substantially enhance the convenience of the user.

In accordance with the present invention, the storage media for abolishing the restriction between the hardware models and the software processes, and for simply utilizing a desired software process in any hardware models, and for automating the adjustment thereof, and the computer system including the storage media can be provided.

As described above, the present invention has been described according to the preferred embodiments, but the present invention is not intended to be restrictive by the above described embodiments, and the various modifications can be made within the scope described in the claims thereof.

We claim:

1. A computer system comprising:
(a) a computer;
(b) an optical disc, including:
(i) a data storage portion arranged and configured to store a particular operating system (“OS”), and a plurality of emulators which make the particular OS operable for different types of computers, the plurality of emulators being defined as stored emulators;
(ii) an electronic circuit, the electronic circuit including a data processing portion and memory storing a list of contents stored in the data storage portion, wherein the data processing portion is configured to read the list of contents and to send the list of contents to the computer when the optical disc is operatively connected to the computer; and
(c) wherein the computer is arranged and configured to receive an instruction to change to the particular OS and
(i) if an emulator for the particular OS is located on the computer, then the computer reads the particular OS from the data storage portion;
(ii) if an emulator is not stored on the computer, then the computer reads one of the stored emulators and the particular OS from the data storage portion,
whereby the computer is arranged and configured to then execute the particular OS and the emulator located on the computer.

2. The computer system of claim 1, wherein the data storage portion comprises random access memory for storing fixed information.

3. The computer system of claim 1, wherein the data storage portion comprises read only memory to temporarily store data.

4. The computer system of claim 1, wherein the data processing portion comprises a central processing unit.

5. The computer system of claim 1, further comprising an optical disc drive unit for receiving the optical disc.

6. The computer system of claim 1, wherein the electronic circuit further comprises a system interface for exchanging information with an external device.

7. The computer system of claim 1, wherein the electronic circuit further comprises a communication control circuit for downloading a desired emulator by making an auto-call to a software provider.

8. A computer system to which an optical disc having a data storage portion and an electronic circuit mounted thereon is to be attached, wherein:
the data storage portion stores a particular operating system (“OS”), and a plurality of emulators which make the particular OS operable for a specified computer kind;
the electronic circuit includes a data processing portion and a memory storing a list of contents stored in the data storage portion;
when the optical disc is attached to the computer, the data processing portion sends the contents list read out from the data storage portion to the computer; and
the computer, responsive to receipt of the contents list and a change instruction of the particular OS, when the emulator adapted to the computer kind is included in the computer only the particular OS is read out from the data storage portion, when the emulator adapted to the own computer kind is not included in the computer particular OS and the emulator to be adapted are read out from the data storage portion, and the read out OS, and the read out particular OS and emulator are executed.
